(19) United States
(12) Patent Application Publication
(10) Pub. No.: US 2023/0123342 A1
(43) Pub. Date: Apr. 20, 2023

(54) VULNERABILITY DETERMINATION DEVICE, VULNERABILITY DETERMINATION METHOD, AND VULNERABILITY DETERMINATION PROGRAM

(71) Applicant: NIPPON TELEGRAPH AND TELEPHONE CORPORATION, Tokyo (JP)

(72) Inventors: Takuya WATANABE, Musashino-shi, Tokyo (JP); Eitaro SHIOJI, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 17/911,136

(22) PCT Filed: Mar. 16, 2020
(86) PCT No.: PCT/JP2020/011557

§ 371 Date: Sep. 13, 2022

(51) Int. Cl. H04L 9/40

(52) U.S. Cl. CPC H04L 63/1433; H04L 63/1416; H04L 63/1483

(57) ABSTRACT

A vulnerability determination apparatus includes processing circuitry configured to input URLs of a plurality of websites to be rehosted to a rehosting apparatus, the rehosting apparatus being configured to rehost the plurality of websites and display the plurality of websites on a user terminal, acquire a response to the input of the URLs from the rehosting apparatus, the response including contents and URLs of the plurality of websites after the rehosting, and identify, based on the acquired response, at least one of a URL set for each of the plurality of websites after the rehosting, presence or absence of a setting for writing a cookie in the plurality of websites, and presence or absence of a code for accessing a predetermined function of a browser in the plurality of websites and determine an attack that is likely to occur due to the rehosting of the plurality of websites.

### TECHNICAL FIELD

The present invention relates to a vulnerability determination apparatus, a vulnerability determination method, and a vulnerability determination program.

### BACKGROUND ART

For example, there is a service for rehosting a website on another website and displaying the website to a user for the purpose of providing a translation service or avoiding censorship of contents of websites, for example. Hereinafter, such a service will be referred to as web rehosting. For example, Google Translate (trade name), Wayback Machine, ProxySite, and the like correspond to the above web rehosting.

In the above web rehosting, even when groups of websites to be rehosted have different origins (for example, a domain, port, and scheme), these groups of websites are placed in the same origin after the rehosting. Thus, when a malicious website is included in the groups of websites to be rehosted, there is concern that such a website may break through a security boundary and attack other websites in web rehosting.

For example, even when domains of uniform resource locators (URLs) of websites A, B, and C to be rehosted differ, the domains of the URLs of the websites A, B, and C may become the same domain (rehosted.example) through web rehosting, as illustrated in FIG. 1. In such a case, when websites to be rehosted include an attacker site (for example, the website C), there is concern that an attack on the websites A and B from the attacker site (the website C) may be carried out after the rehosting. Thus, it is important to investigate the vulnerability of a web rehosting service in order to prevent the above attacks.

### CITATION LIST

### Non Patent Literature

[NPL 1] D. Martin and A. Schulman, “DEANONYMIZING USERS OF THE SAFEWEB ANONYMIZING SERVICE”, in 11th USENIX Security Symposium (USENIX Security 02), 2002.

### SUMMARY OF THE INVENTION

### Technical Problem

Here, for example, there has been a technology for individually investigating vulnerability in websites in the related art. However, the above vulnerability of web rehosting services has not been uniformly investigated. Thus, an object of the present invention is to uniformly investigate vulnerability in a web rehosting service.

### Means for Solving the Problem

In order to solve the above-described problem, the present invention includes a URL input unit configured to input URLs of a plurality of websites to be rehosted to a rehosting apparatus, the rehosting apparatus being configured to rehost the plurality of websites and display the plurality of websites on a user terminal; a response acquisition unit configured to acquire a response to the input of the URLs from the rehosting apparatus, the response including contents and URLs of the plurality of websites after the rehosting; and a determination unit configured to identify, based on the acquired response, at least one of a URL set for each of the plurality of websites after the rehosting, presence or absence of a setting for writing a cookie in the plurality of websites, and presence or absence of a code for accessing a predetermined function of a browser in the plurality of websites and determine an attack that is likely to occur due to the rehosting of the plurality of websites by using a result of the identification.

### Effects of the Invention

According to the present invention, it is possible to uniformly investigate vulnerability in a web rehosting service.

### BRIEF DESCRIPTION OF DRAWINGS

FIG. 1 is a diagram illustrating web rehosting.

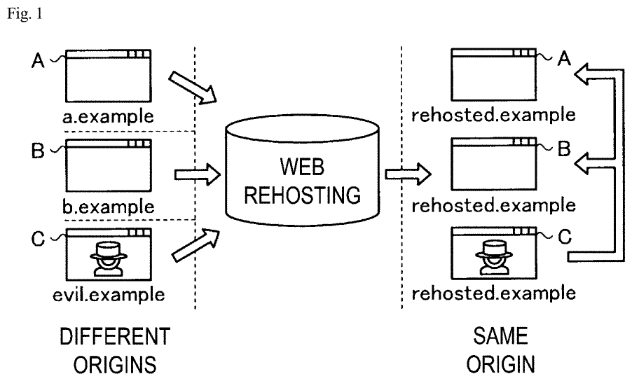

FIG. 2 is a diagram illustrating an example of an attack that is likely to occur in web rehosting.

FIG. 3 is a diagram illustrating an example of an attack caused when a user terminal accesses a normal site after accessing an attacker site.

FIG. 4 is a diagram illustrating an example of an attack caused when a user terminal accesses an attacker site after accessing a normal site.

FIG. 5 is a diagram illustrating an overview of determination of web rehosting vulnerability by a vulnerability determination apparatus.

FIG. 6 is a diagram illustrating an example of an investigation site X.

FIG. 7 is a diagram illustrating a configuration example of a vulnerability determination apparatus.

FIG. 8 is a diagram illustrating an example of attack determination information illustrated in FIG. 7.

FIG. 9 is a flowchart illustrating an example of a processing procedure of the vulnerability determination apparatus.

FIG. 10 is a diagram illustrating a configuration example of a computer that executes a vulnerability determination program.

### DESCRIPTION OF EMBODIMENTS

Hereinafter, a mode for carrying out the present invention (embodiment) will be described with reference to the drawings. The present invention is not limited to the embodiments to be described below.

### Attack

First, an attack to be determined by the vulnerability determination apparatus of the present embodiment will be described. In the present embodiment, it is assumed that the attack to be determined by the vulnerability determination apparatus is an attack that occurs when the user terminal browses an attacker site through a web rehosting service.

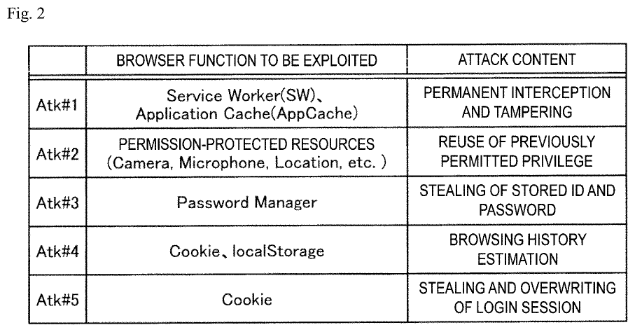

Examples of the attack include attacks of Atk #1 to Atk #5 illustrated in FIG. 2.

Atk #1: Functions of a service worker (SW) and application cache (AppCache) of a browser are exploited, and access to other websites is permanently intercepted and tampered with.

Atk #2: Permission-protected resources (a camera, microphone, location, and the like) in a browser are exploited and a previously permitted privilege is reused.

Atk #3: A function of a password manager of a browser is exploited, and an ID and a password stored in the browser are stolen.

Atk #4: A cookie and a localStorage of a browser are exploited, and a browsing history of the browser is estimated.

Atk #5: A cookie of a browser is exploited, and a login session of the browser is stolen or overwritten.

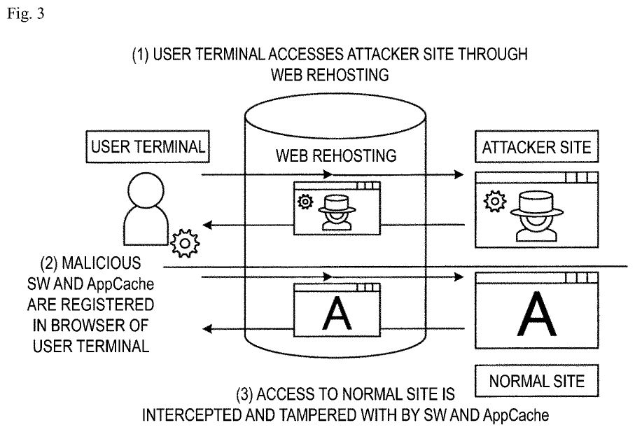

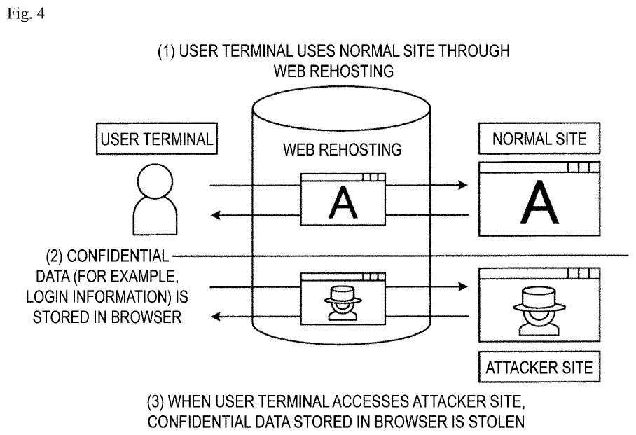

The above attacks can be divided into an attack caused when the user terminal accesses an attacker site and then accesses a normal site (see FIG. 3), and an attack caused when the user terminal accesses a normal site and then accesses an attacker site (see FIG. 4).

Atk #1 is an attack caused when the user terminal accesses an attacker site and then accesses a normal site. Further, Atk #2 to Atk #5 are attacks caused when the user terminal accesses a normal site and then accesses an attacker site. These attacks will be described with reference to FIGS. 3 and 4.

First, the attack caused when the user terminal accesses an attacker site and then accesses a normal site will be described with reference to FIG. 3. For example, when the user terminal visits an attacker site through web rehosting ((1) in FIG. 3), a malicious service worker (SW) and application cache are registered in the browser of the user terminal ((2) in FIG. 3). Thereafter, when the user terminal accesses a normal site through web rehosting, the access to the normal site is intercepted and tampered with by the SW and the application cache ((3) in FIG. 3).

Next, an attack caused when the user terminal accesses a normal site and then accesses an attacker site will be described with reference to FIG. 4. For example, when the user terminal uses a normal site through web rehosting ((1) in FIG. 4), confidential data (for example, login information) is stored in the browser of the user terminal ((2) in FIG. 4). Thereafter, when the user terminal accesses an attacker site, the confidential data stored in the browser is stolen ((3) in FIG. 4).

### Overview

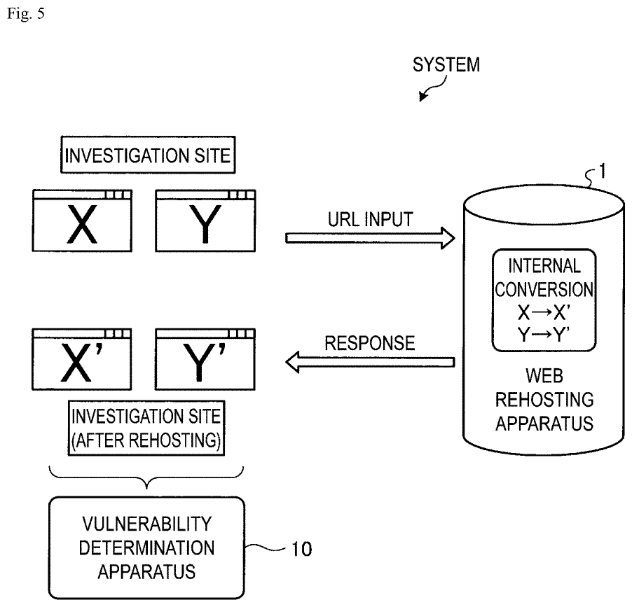

Next, an overview of determination of the vulnerability of the web rehosting by the vulnerability determination apparatus will be described with reference to FIG. 5.

First, a configuration example of a system including the vulnerability determination apparatus 10 will be described. The system includes a web rehosting apparatus (rehosting apparatus) 1 and a vulnerability determination apparatus 10.

The web rehosting apparatus 1 performs rehosting of a plurality of websites. For example, the web rehosting apparatus 1 rehosts a plurality of websites and displays the websites on the user terminal.

The vulnerability determination apparatus 10 determines the vulnerability of the web rehosting by the web rehosting apparatus 1. The web rehosting apparatus 1 and the vulnerability determination apparatus 10 are communicatively connected via a network such as the Internet.

In order to determine the vulnerability of web rehosting in the vulnerability determination apparatus 10, a system administrator or the like prepares investigation sites X and Y (to be described below). The vulnerability determination apparatus 10 inputs the URLs of the investigation sites X and Y to the web rehosting apparatus 1. Thereafter, the web rehosting apparatus 1 performs internal conversion of the investigation sites X and Y in order to perform web rehosting of the input investigation sites X and Y. For example, the web rehosting apparatus 1 converts the URLs of the investigation sites X and Y. The web rehosting apparatus 1 returns a response to the input of the URLs of the investigation sites X and Y to the vulnerability determination apparatus 10. For example, the web rehosting apparatus 1 returns the URLs, contents, and the like of the rehosted investigation sites X and Y (investigation sites X′ and Y′) to the vulnerability determination apparatus 10. The vulnerability determination apparatus 10 determines an attack that is likely to occur at the investigation sites X′ and Y′ based on the response.

### Investigation Site

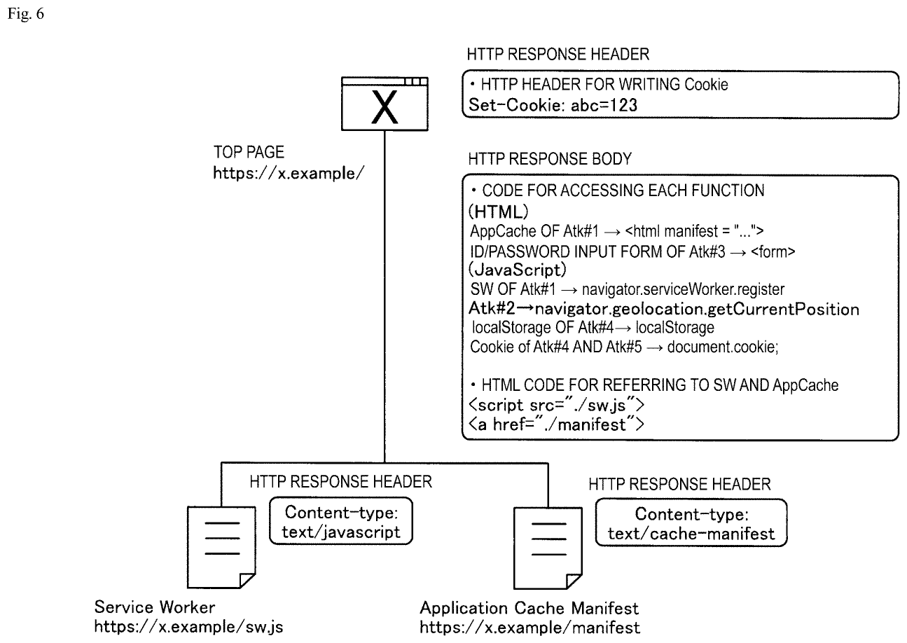

Here, the investigation sites X and Y will be described. For example, the investigation site X is set so that a top page is https://x.example/ and a code (sw.js) regarding a service worker and an application cache manifest (manifest) are placed under this top page, as illustrated in FIG. 6.

It is assumed that the top page of the investigation site X is set so that an HTTP response from the top page has the following contents. Atk #1 to Atk #5 described below correspond to the attack patterns illustrated in FIG. 2.

For example, an HTTP header for writing a cookie (for example, Set-Cookie: abc=123) is set in an HTTP response header, as illustrated in FIG. 6. Thus, the vulnerability determination apparatus 10 can determine whether an attack using a cookie of Atk #4 and Atk #5 is likely to occur after the investigation site X is rehosted.

Further, a code (a code using HTML or JavaScript (trade name)) for accessing each function of the browser is set in an HTTP response body.

For example, <html manifest=“ . . . ”> is set in the HTTP response body, as illustrated in FIG. 6. Thus, the vulnerability determination apparatus 10 can determine whether an attack using AppCache of Atk #1 is likely to occur after the investigation site X is rehosted.

Further, <form>, which is an ID/password input form, is set in the HTTP response body. Thus, the vulnerability determination apparatus 10 can determine whether an attack using an ID and a password of Atk #3 is likely to occur after the investigation site X is rehosted.

Further, navigator. serviceWorker.register is set in the HTTP response body. Thus, the vulnerability determination apparatus 10 can determine whether an attack using SW of Atk #1 is likely to occur after the investigation site X is rehosted.

Further, navigator.geolocation.getCurentPosition is set in the HTTP response body. Thus, the vulnerability determination apparatus 10 can determine whether an attack using a permission-protected resource (for example, location) of Atk #2 is likely to occur after the investigation site X is rehosted.

Further, for example, a localStorage is set in the HTTP response body. Thus, the vulnerability determination apparatus 10 can determine whether an attack using localStorage of Atk #4 is likely to occur after the investigation site X is rehosted.

Further, for example, document.cookie; is set in the HTTP response body. Thus, the vulnerability determination apparatus 10 can determine whether an attack using a cookie of Atk #4 and Atk #5 is likely to occur after the investigation site X is rehosted.

Further, the following HTML codes referring to an SW and an AppCache are also set in the HTTP response body.

<script src=“./sw.js”>

<a href=“./manifest”>

Thus, the vulnerability determination apparatus 10 can check what URLs sw.js and manifest placed in the investigation site X after rehosting are converted into.

In addition, text/javascript is set as a content-type in an HTTP response header of sw.js (https://x.example/sw.js) described above. Further, text/cache-manifest is set as a content-type in an HTTP response header of manifest (https://x.example/manifest) described above. Thus, the vulnerability determination apparatus 10 can determine whether an attack using SW and AppCache of Atk #1 is likely to occur at the investigation site X after rehosting.

In addition, the investigation site Y is used for check regarding what URL the original URL is converted into after rehosting by the web rehosting apparatus 1, and thus the content can be any content as long as a URL having a domain different from that of the investigation site X is set. For example, “https://y.example/” that is a URL having a domain different from that of the investigation site X is set as a URL of a top page of the investigation site Y.

### Configuration

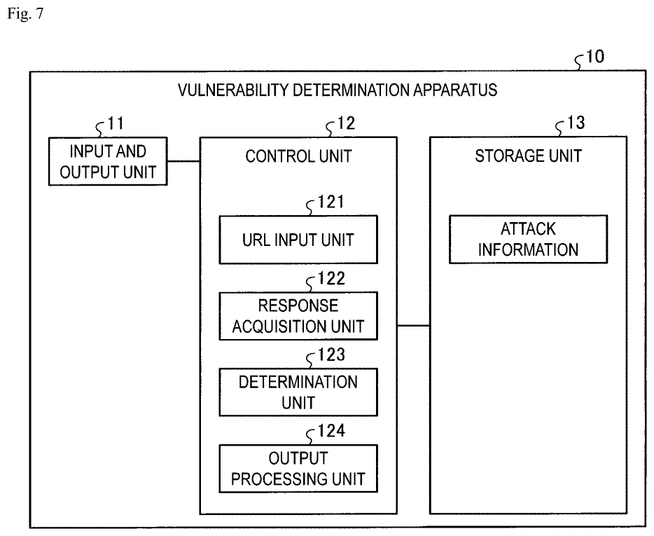

Next, a configuration example of the vulnerability determination apparatus 10 will be described with reference to FIG. 7. The vulnerability determination apparatus 10 includes an input and output unit 11, a control unit 12, and a storage unit 13.

The input and output unit 11 is an interface for receiving an input of various pieces of data from an external apparatus or outputting various pieces of data to the external apparatus. The input and output unit 11 outputs, for example, URLs of websites to be rehosted to the web rehosting apparatus 1, or receives an input of a response from the web rehosting apparatus 1.

The control unit 12 controls the entire vulnerability determination apparatus 10. The control unit 12 includes an internal memory for storing a program that defines various processing procedures or the like and required data, and executes various processing using the program and the data. For example, the control unit 12 is an electronic circuit such as a central processing unit (CPU) or a micro processing unit (MPU). The control unit 12 functions as various processing units by operations of various programs.

The control unit 12 includes a URL input unit 121, a response acquisition unit 122, a determination unit 123, and an output processing unit 124.

The URL input unit 121 inputs the URLs of websites to be rehosted (for example, the investigation sites X and Y) to the web rehosting apparatus 1.

The response acquisition unit 122 acquires a response (for example, a content, URL, and the like of each of the plurality of websites after the rehosting is performed by the web rehosting apparatus 1) to the input of the URLs from the web rehosting apparatus 1.

The determination unit 123 determines an attack that is likely to occur due to the rehosting of the plurality of websites based on the response acquired by the response acquisition unit 122.

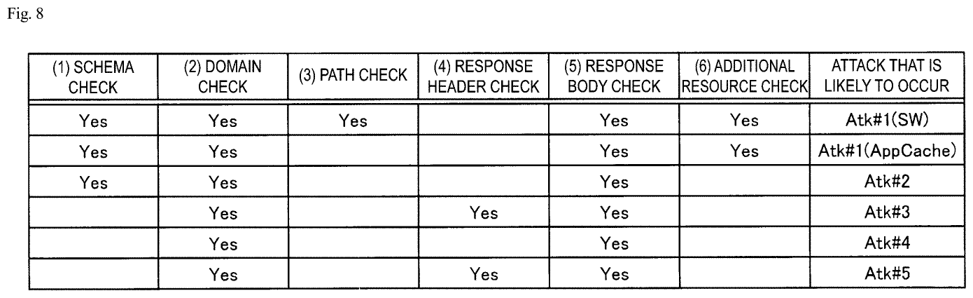

For example, the determination unit 123 identifies, for example, a URL set for each of the plurality of websites after rehosting, the presence or absence of a setting for writing a cookie in the plurality of websites, and the presence or absence of a code for accessing a predetermined function of the browser in the plurality of websites, based on the response (for example, the content and URL of each of the plurality of websites after rehosting is performed by the web rehosting apparatus 1) acquired by the response acquisition unit 122. The determination unit 123 determines an attack that is likely to occur due to the rehosting of the plurality of websites using a result of the identification and the attack information (see FIG. 8) of the storage unit 13. The output processing unit 124 outputs a determination result of the determination unit 123 via the input and output unit 11.

For example, the determination unit 123 checks the following items (1) to (6) for the contents and URLs of the investigation sites X′ and Y′ after the rehosting.

(1) Schema check: Whether a schema of a URL of the investigation site X′ is https.

(2) Domain check: Whether domains of the URLs of the investigation site X′ and the investigation site Y′ are the same.

(3) Path check: Whether paths of the URLs of the investigation site X′ and the investigation site Y′ are in the same layer.

(4) Response header check: Whether a setting for writing a cookie is valid in an HTTP response header of the investigation site X′.

(5) Response body check: Whether a code for accessing each function of the browser is valid in the HTTP response body of the investigation site X′.

(6) Additional resource check: Whether a correct content-type is set in sw.js and manifest under the investigation sites X′.

The determination unit 123 determines an attack that is likely to occur due to the rehosting of the investigation sites X and Y, based on check results of the items (1) to (6) regarding the response to the URL input. For example, the determination unit 123 determines a type of attack (for example, Atk #1 to Atk #5 illustrated in FIG. 2) that is likely to occur due to rehosting of the investigation sites X and Y with reference to the results of check (check results) of the items in (1) to (6) and the attack determination information illustrated in FIG. 8.

The attack determination information is information indicating, for each type of attack that is likely to occur, a combination of check results of the items (1) to (6) in which this type of attack is likely to occur. Blank fields in FIG. 8 indicate that corresponding items may or may not be satisfied (may be Yes or No).

For example, information on a first line of the attack determination information illustrated in FIG. 8 indicates (1) the URL schema of the investigation site X′ is https, (2) the domains of the URLs of the investigation site X′ and the investigation site Y′ are the same, (3) the paths of the URLs of the investigation site X′ and the investigation site Y′ are in the same layer, (5) the code for accessing each function of the browser is valid in the HTTP response body of the investigation site X′, and (6) an attack of Atk #1 regarding SW is likely to occur due to rehosting of the investigation sites X and Y when a correct content-type is set in sw.js and manifest under the investigation sites X′.

Further, information on a second line of the attack determination information illustrated in FIG. 8 indicates (1) the schema of the URL of the investigation site X′ is https, (2) the domains of the URLs of the investigation site X′ and the investigation site Y′ are the same, (5) the code for accessing each function of the browser is valid in the HTTP response body of the investigation site X′, and (6) an attack of Atk #1 regarding AppCache is likely to occur due to rehosting of the investigation sites X and Y when a correct content-type is set in sw.js and manifest under the investigation sites X′.

Further, information on a third line of the attack determination information illustrated in FIG. 8 indicates (1) the schema of the URL of the investigation site X′ is https, (2) the domains of the URLs of the investigation site X′ and the investigation site Y′ are the same, and (5) an attack of Atk #2 is likely to occur due to rehosting of the investigation sites X and Y when the code for accessing each function of the browser is valid in the HTTP response body of the investigation site X′.

Further, information on a fourth line of the attack determination information illustrated in FIG. 8 indicates (2) the domains of the URLs of the investigation site X′ and the investigation site Y′ are the same, (4) the setting for writing a cookie is valid in the HTTP response header of the investigation site X′, and (5) an attack of Atk #3 is likely to occur due to rehosting of the investigation sites X and Y when the code for accessing each function of the browser is valid in the HTTP response body of the investigation site X′.

Further, information on a fifth line of the attack determination information illustrated in FIG. 8 indicates (2) the domains of the URLs of the investigation site X′ and the investigation site Y′ are the same, and (5) an attack of Atk #4 is likely to occur due to rehosting of the investigation sites X and Y when the code for accessing each function of the browser is valid in the HTTP response body of the investigation site X′.

Further, information on a sixth line of the attack determination information illustrated in FIG. 8 indicates (2) the domains of the URLs of the investigation site X′ and the investigation site Y′ are the same, (4) the setting for writing a cookie is valid in the HTTP response header of the investigation site X′, and (5) an attack of Atk #5 is likely to occur due to rehosting of the investigation sites X and Y when the code for accessing each function of the browser is valid in the HTTP response body of the investigation site X′.

The attack determination information can be appropriately changed by an administrator of the vulnerability determination apparatus 10 or the like.

The storage unit 13 of FIG. 7 is achieved by, for example, a semiconductor memory element such as a random access memory (RAM) or a flash memory, or a storage apparatus such as a hard disk or an optical disc, and stores a processing program for operating the vulnerability determination apparatus 10, data used during execution of the processing program, and the like. For example, the attack determination information (see FIG. 8) is stored in the storage unit 13.

### Processing Procedure

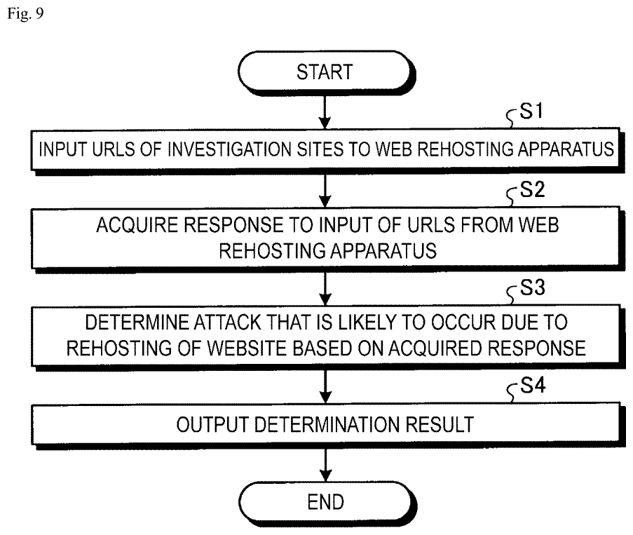

Next, an example of a processing procedure of the vulnerability determination apparatus 10 will be described with reference to FIG. 9. It is assumed that the investigation sites X and Y are prepared in advance.

First, the URL input unit 121 of the vulnerability determination apparatus 10 inputs the URLs of the investigation sites to the web rehosting apparatus 1 (S1). Thereafter, the response acquisition unit 122 acquires a response (for example, contents and URLs of the investigation sites X and Y after rehosting) to the input of the URLs in S1 from the web rehosting apparatus 1 (S2).

After S2, the determination unit 123 determines an attack that is likely to occur due to the rehosting of the websites (the investigation sites X and Y) based on the response obtained in S2 (S3). The output processing unit 124 outputs a determination result of S3 (S4).

According to such a vulnerability determination apparatus 10, it is possible to determine the vulnerability of the web rehosting service.

### Program

Further, a program for achieving a function of the vulnerability determination apparatus 10 described in the above embodiment can be implemented by being installed in a desired information processing apparatus (computer). For example, it is possible to cause the computer to function as the vulnerability determination apparatus 10 by causing the computer to execute the above program provided as package software or online software. The computer referred to here includes a desktop or laptop personal computer, a rack-mounted server computer, and the like. In addition, a smartphone, a mobile phone, a mobile communication terminal such as a personal handyphone system (PHS), a personal digital assistants (PDA), and the like are included in a category of the computer. Further, the function of the vulnerability determination apparatus 10 may be implemented in a cloud server.

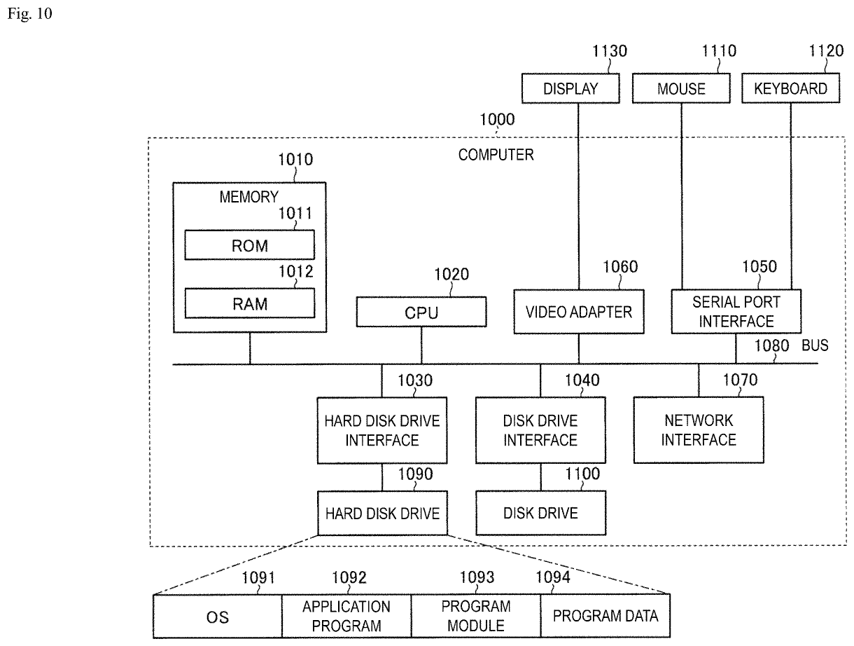

An example of a computer that executes the program (vulnerability determination program) will be described with reference to FIG. 10. A computer 1000 includes, for example, a memory 1010, a CPU 1020, a hard disk drive interface 1030, a disc drive interface 1040, a serial port interface 1050, a video adapter 1060, and a network interface 1070, as illustrated in FIG. 10. These units are connected by a bus 1080.

The memory 1010 includes a read only memory (ROM) 1011 and a RAM 1012. The ROM 1011 stores, for example, a boot program, such as a basic input output system (BIOS). The hard disk drive interface 1030 is connected to a hard disk drive 1090. The disc drive interface 1040 is connected to a disc drive 1100. A detachable storage medium such as a magnetic disk or an optical disc, for example, is inserted into the disc drive 1100. A mouse 1110 and a keyboard 1120, for example, are connected to the serial port interface 1050. A display 1130, for example, is connected to the video adapter 1060.

Here, the hard disk drive 1090 stores, for example, an OS 1091, an application program 1092, a program module 1093, and program data 1094, as illustrated in FIG. 10. The storage unit 13 described in the above embodiments is mounted in, for example, the hard disk drive 1090 or the memory 1010.

The CPU 1020 reads the program module 1093 or the program data 1094 stored in the hard disk drive 1090 into the RAM 1012, as necessary, and executes each of the above-described procedures.

The program module 1093 and the program data 1094 relevant to the above vulnerability determination program are not limited to being stored in the hard disk drive 1090 and, for example, may be stored in a detachable storage medium and read by the CPU 1020 via the disc drive 1100 or the like. Alternatively, the program module 1093 and the program data 1094 relevant to the program may be stored in another computer connected via a network such as a LAN or a wide area network (WAN) and read by the CPU 1020 via the network interface 1070.

### REFERENCE SIGNS LIST

1 Web rehosting apparatus

10 Vulnerability determination apparatus

11 Input and output unit

12 Control unit

13 Storage unit

121 URL input unit

122 Response acquisition unit

123 Determination unit

124 Output processing unit

1. A vulnerability determination apparatus comprising:
processing circuitry configured to:
input URLs of a plurality of websites to be rehosted to a rehosting apparatus, the rehosting apparatus being configured to rehost the plurality of websites and display the plurality of websites on a user terminal;
acquire a response to the input of the URLs from the rehosting apparatus, the response including contents and URLs of the plurality of websites after the rehosting; and
identify, based on the acquired response, at least one of a URL set for each of the plurality of websites after the rehosting, presence or absence of a setting for writing a cookie in the plurality of websites, and presence or absence of a code for accessing a predetermined function of a browser in the plurality of websites and determine an attack that is likely to occur due to the rehosting of the plurality of websites by using a result of the identification.

2. The vulnerability determination apparatus according to claim 1, wherein
the processing circuitry is further configured to identify, based on the acquired response, whether domains in the URLs set for the plurality of websites after the rehosting are same, and whether layers of paths of the URLs are same and determine an attack that is likely to occur due to the rehosting of the plurality of websites by using a result of the identification.

3. The vulnerability determination apparatus according to claim 1, wherein
the processing circuitry is further configured to identify, based on the acquired response, whether a correct content-type is set for a service worker and an application cache manifest of any of the plurality of websites after the rehosting and determine an attack that is likely to occur due to the rehosting of the plurality of websites by using a result of the identification.

4. The vulnerability determination apparatus according to claim 1, wherein
the attack that is likely to occur due to the rehosting of the plurality of websites is any one or a combination of interception or tampering of access to other websites using a service worker or application cache of the browser, reuse of a previously permitted privilege in the browser, stealing of an ID and a password stored in the browser, estimation of a browsing history by the browser, and stealing or overwriting of a login session to other websites.

5. A vulnerability determination method executed by a vulnerability determination apparatus, the vulnerability determination method comprising:
inputting URLs of a plurality of websites to be rehosted to a rehosting apparatus, the rehosting apparatus being configured to rehost the plurality of websites and display the plurality of websites on a user terminal;
acquiring a response to the input of the URLs from the rehosting apparatus, the response including contents and URLs of the plurality of websites after the rehosting; and
identifying, based on the acquired response, at least one of a URL set for each of the plurality of websites after the rehosting, presence or absence of a setting for writing a cookie in the plurality of websites, and presence or absence of a code for accessing a predetermined function of a browser in the plurality of websites and determining an attack that is likely to occur due to the rehosting of the plurality of websites by using a result of the identification.

6. A non-transitory computer-readable recording medium storing therein a vulnerability determination program that causes a computer to execute a process comprising:
inputting URLs of a plurality of websites to be rehosted to a rehosting apparatus, the rehosting apparatus being configured to rehost the plurality of websites and display the plurality of websites on a user terminal;
acquiring a response to the input of the URLs from the rehosting apparatus, the response including contents and URLs of the plurality of websites after the rehosting; and
identifying, based on the acquired response, at least one of a URL set for each of the plurality of websites after the rehosting, presence or absence of a setting for writing a cookie in the plurality of websites, and presence or absence of a code for accessing a predetermined function of a browser in the plurality of websites and determining an attack that is likely to occur due to the rehosting of the plurality of websites by using a result of the identification.
